(19) United States
(12) Patent Application Publication
(10) Pub. No.: US 2013/0293487 A1
(43) Pub. Date: Nov. 7, 2013

(54) TOUCH PANEL

(71) Applicant: HENGHAO TECHNOLOGY CO. LTD, Taoyuan County (TW)

(72) Inventors: KUAN-YEN MA, Taoyuan County (TW); Chien-Wen Lai, New Taipei City (TW)

(73) Assignee: HENGHAO TECHNOLOGY CO. LTD, Taoyuan County (TW)

(21) Appl. No.: 13/676,972

(22) Filed: Nov. 14, 2012

Related U.S. Application Data
(60) Provisional application No. 61/642,505, filed on May 4, 2012.

(30) Foreign Application Priority Data
Aug. 28, 2012 (TW) 101131181

(51) Int. Cl. G06F 3/01

(52) U.S. Cl. CPC G06F 3/01
USPC 345/173

(57) ABSTRACT

The present invention is directed to a touch panel. The touch panel includes a light shielding layer disposed on a bottom surface of at least one peripheral edge of a transparent substrate. An optical layer with a refractive index greater than 1.5 is disposed on a surface of the transparent substrate. A touch sensing layer is disposed below the transparent substrate.

### CROSS-REFERENCE TO RELATED APPLICATIONS

This application claims the benefit of U.S. Provisional Application No. 61/642,505, filed on May 4, 2012 and entitled TOUCH SENSING PANEL, and claims priority to Taiwan Patent Application No. 101131181, filed on Aug. 28, 2012, the entire contents both of which are hereby incorporated by reference.

### BACKGROUND OF THE INVENTION

1. Field of the Invention

The present invention generally relates to a touch panel, and more particularly to a touch panel having an optical layer with a high refractive index.

2. Description of Related Art

A touch screen is an input/output device that adopts sensing technology and display technology, and has been widely employed in electronic devices such as portable or hand-held electronic devices.

A capacitor-based touch panel is a commonly used touch panel that utilizes capacitive coupling effect to detect touch position. Specifically, capacitance corresponding to the touch position changes and is thus detected, when a finger touches a surface of the touch panel.

FIG. 1 shows a top view of a touch sensing layer of a conventional touch panel. The touch sensing layer includes vertical electrode lines 11 and horizontal electrode lines 12 formed on the same surface of a glass plate, and are electrically insulated from each other by insulation bridges 13. In the conventional touch panel as shown in FIG. 1, gap need be reserved for preventing electrically shoring between the vertical electrode lines 11 and the horizontal electrode lines 12. Accordingly, trace phenomenon occurs when users look at the touch panel.

FIG. 2A and FIG. 2B show a top view and a cross-sectional view, respectively, of a conventional touch panel. A black matrix (BM) 22 is disposed on a bottom surface of a peripheral edge of the glass substrate 21, and a touch sensing layer 23 is disposed on a bottom surface of the glass substrate 21 and the black matrix 22. The touch sensing layer 23 includes a sensing portion 231 not covered by the black matrix 22 and a routing portion 232 located below the black matrix 22. In theory, the sensing portion 231 defines an active area or a touching range 24. In practice, however, as the touch sensing layer 23 is very thin, the peripheral area 25 (i.e., an area between the touching range 24 and an area 26) of the sensing portion 231 sometimes suffers from broken wire.

For the reason that the conventional touch panel possesses visual trace, a need has arisen to propose a novel touch panel to overcome disadvantages of the conventional touch panel.

### SUMMARY OF THE INVENTION

In view of the foregoing, it is an object of the embodiment of the present invention to provide a touch panel that utilizes an optical layer with high refractive index to improve visual trace phenomenon, and uses a light shielding layer with an oblique surface to improve a touchable range of the touch panel.

According to one embodiment, a touch panel includes a transparent substrate, a light shielding layer, an optical layer and a touch sensing layer. The light shielding layer is disposed on a bottom surface of at least one peripheral edge of the transparent substrate. The optical layer has a refractive index greater than 1.5, and is disposed on a surface of the transparent substrate. The touch sensing layer is disposed below the transparent substrate.

### BRIEF DESCRIPTION OF THE DRAWINGS

FIG. 1 shows a top view of a touch sensing layer of a conventional touch panel;

FIG. 2A and FIG. 2B show a top view and a cross-sectional view, respectively, of a conventional touch panel;

FIG. 3A and FIG. 3B show a top view and a cross-sectional view, respectively, of a touch panel according to a first embodiment of the present invention;

FIG. 4 shows a cross-sectional view of a touch panel according to a second embodiment of the present invention; and

FIG. 5 shows a cross-sectional view of a touch panel according to a third embodiment of the present invention.

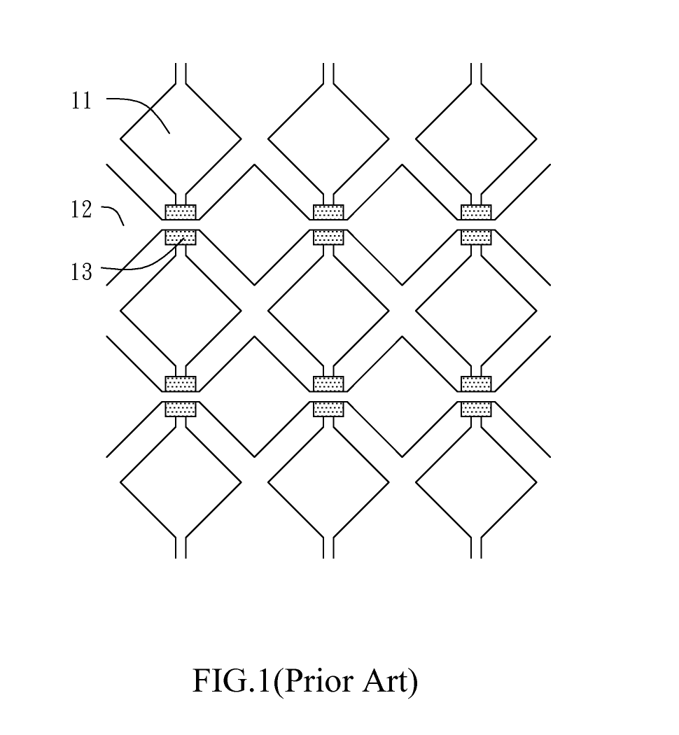

### DETAILED DESCRIPTION OF THE INVENTION

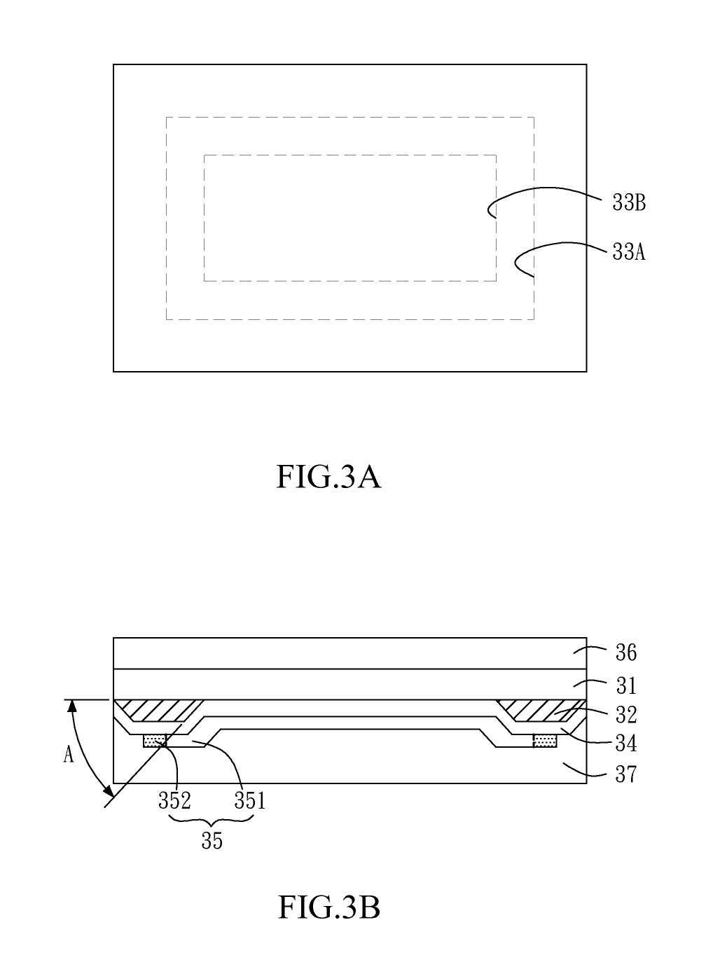

FIG. 3A and FIG. 3B show a top view and a cross-sectional view, respectively, of a touch panel according to a first embodiment of the present invention. For better understanding, only composing elements pertinent to the embodiment are shown in the figures.

As shown in FIG. 3A/B, a transparent substrate 31 is first provided. The transparent substrate 31 may include transparent insulation material with high transmittance, such as glass, Polycarbonate (PC), Polyethylene terephthalate (PET), Polymethyl methacrylate (PMMA) or Cyclic olefin copolymer (COC).

A light shielding layer 32 is disposed on a bottom surface of at least one peripheral edge of the transparent substrate 31. Although the light shielding layer 32 is disposed on four peripheral edges of the transparent substrate 31 in the exemplary embodiment, the amount of the peripheral edges is not limited to that as shown. The light shielding layer 32 of the embodiment may, but not necessarily, be a black matrix (BM), and may generally include conductive or insulated material that is capable of shielding against light. In the specification, a direction “top” points to a touch surface of the touch panel, and a direction “bottom” points to a direction opposite the touch surface.

According to one aspect of the embodiment, the light shielding layer 32 has an oblique surface or sidewall. In one embodiment, an intersection angle A, less than 50 degrees, is made by the oblique surface of the light shielding layer 32 and a bottom surface of the transparent substrate 31. It will be described later in the specification that the oblique surface of the light shielding layer 32 enlarges the touchable range of the touch panel of the embodiment from an original active area 33B to an enlarged active area 33A.

According to another aspect of the embodiment, an optical layer 34 with high refractive index (e.g., greater than 1.5) is disposed on a surface (e.g., a bottom surface) of the transparent substrate 31. The optical layer 34 of the embodiment may include transparent organic material such as photoresist, or transparent inorganic material such as silicon oxide (e.g., silicon dioxide) or metal oxide. The optical layer 34 may be formed in one of various manners such as physical vapor deposition, chemical vapor deposition, coating, printing or spinning. In the embodiment, the optical layer 34 covers the bottom surface of the light shielding layer 32 in addition to the bottom surface of the transparent substrate 31.

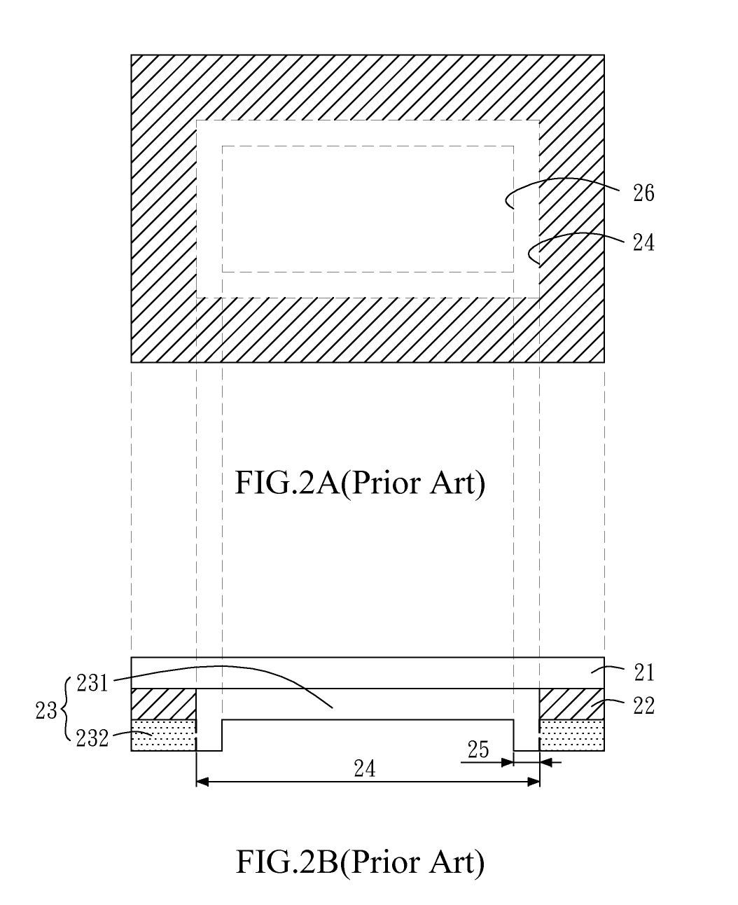

As shown in FIG. 31B, a touch sensing layer 35 is disposed on a bottom surface of the optical layer 34. The touch sensing layer 35 may, but not necessarily, include Indium tin oxide (ITO) or Indium zinc oxide (IZO). Although one touch sensing layer 35 is shown in FIG. 3B, the touch sensing layer 35, nevertheless, may include multiple sub-layers that may be arranged in single-side single-layer, single-side multi-layer, or double-side multi-layer arrangement. The touch sensing layer 35 may include a sensing portion 351 and a routing portion 352. Specifically, the boundary of the sensing portion 351 and the routing portion 352 lies below non-oblique surface of the light shielding layer 32. Accordingly, the sensing portion 351 defines an enlarged active area or an enlarged touchable range 33A. Compared with the conventional touch panel (e.g., FIG. 2A/B) having a black matrix 22 with sharp sidewall, as the light shielding layer 32 of the embodiment has the oblique surface, the sensing portion 351 near the oblique surface (i.e., an area between the enlarged active area 33A and the original active area 33B) no longer suffers from broken wire, and the touchable range of the touch panel is enlarged.

As shown in FIG. 3A/B, the touch panel of the embodiment may further include an anti-reflective layer 36, which is disposed on a top surface of the transparent substrate 31. The anti-reflective layer 36 may be used to reduce light reflection and prevent the transparent substrate 31 from being contaminated. Moreover, the touch panel of the embodiment may further include an overcoating layer 37, which is disposed on a bottom surface of the touch sensing layer 35. The overcoating layer 37 may be used to protect the touch sensing layer 35. The touch panel discussed above may be independently adopted in electronic devices, or may be accompanied with a display panel (not shown) to result in a touch display.

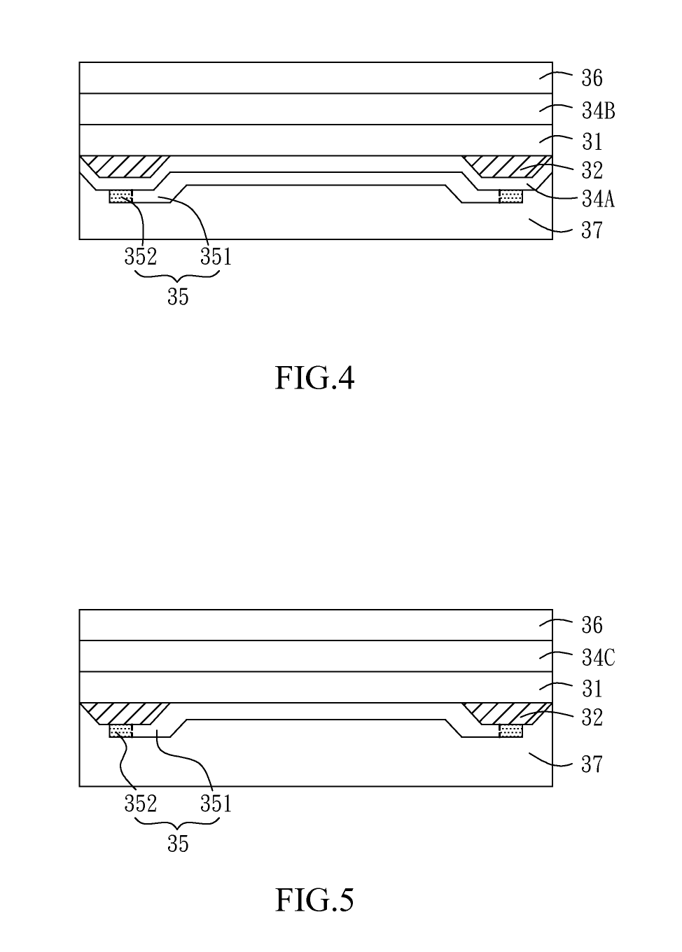

FIG. 4 shows a cross-sectional view of a touch panel according to a second embodiment of the present invention. The top view of FIG. 4 is similar to that shown in FIG. 3A, and is thus omitted for brevity. The present embodiment is similar to the first embodiment (FIG. 3B) with the distinctness that, in addition to a first optical layer 34A disposed between a bottom surface of the transparent substrate 31 and the touch sensing layer 35, the present embodiment further includes a second optical layer 34B disposed between a top surface of the transparent substrate 31 and the anti-reflective layer 36.

FIG. 5 shows a cross-sectional view of a touch panel according to a third embodiment of the present invention. The top view of FIG. 5 is similar to that shown in FIG. 3A, and is thus omitted for brevity. The present embodiment is similar to the second embodiment (FIG. 4) with the distinctness that, a single optical layer 34C is disposed between a top surface of the transparent substrate 31 and the anti-reflective layer 36, but omitting an optical layer disposed between a bottom surface of the transparent substrate 31 and the touch sensing layer 35. Accordingly, the touch sensing layer 35 is directly disposed on a bottom surface of the transparent substrate 31.

According to the embodiments discussed above, as the optical layer 35 with high refractive index is directly or indirectly disposed above the touch sensing layer 35, either touch electrodes of the touch sensing layer 35 or gaps between neighboring touch electrodes perceive substantially the same light reflection (i.e., substantially the same reflectivity) when viewed from top, thereby improving visual trace phenomenon of the touch panel. Moreover, as described above, the light shielding layer of the embodiment has an oblique surface, which enlarges the touchable range of the touch panel.

Although specific embodiments have been illustrated and described, it will be appreciated by those skilled in the art that various modifications may be made without departing from the scope of the present invention, which is intended to be limited solely by the appended claims.

What is claimed is:

1. A touch panel, comprising:
a transparent substrate;
a light shielding layer disposed on a bottom surface of at least one peripheral edge of the transparent substrate;
an optical layer disposed on a surface of the transparent substrate, the optical layer having a refractive index greater than 1.5; and
a touch sensing layer disposed below the transparent substrate.

2. The touch panel of claim 1, wherein the transparent substrate comprises transparent insulation material that is glass, Polycarbonate (PC), Polyethylene terephthalate (PET), Polymethyl methacrylate (PMMA) or Cyclic olefin copolymer (COC).

3. The touch panel of claim 1, wherein the light shielding layer comprises black matrix.

4. The touch panel of claim 1, wherein the light shielding layer has an oblique surface.

5. The touch panel of claim 4, wherein the oblique surface of the light shielding layer and the bottom surface of the transparent substrate make an intersection angle less than 50 degrees.

6. The touch panel of claim 1, wherein the optical layer comprises silicon oxide.

7. The touch panel of claim 1, wherein the optical layer is disposed on the bottom surface of the transparent substrate, and disposed on a bottom surface of the light shielding layer.

8. The touch panel of claim 7, further comprising a second optical layer disposed on a top surface of the transparent substrate.

9. The touch panel of claim 1, wherein the optical layer is disposed on a top surface of the transparent substrate.

10. The touch panel of claim 1, wherein the touch sensing layer comprises transparent conductive material.

11. The touch panel of claim 1, wherein the touch sensing layer comprises a sensing portion and a routing portion, a boundary between the sensing portion and the routing portion lying below a non-oblique surface of the light shielding layer.

12. The touch panel of claim 1, further comprising an anti-reflective layer disposed on a top surface of the transparent substrate.

13. The touch panel of claim 1, further comprising an overcoating layer disposed on a bottom surface of the touch sensing layer.
